(19) United States
(12) Patent Application Publication
(10) Pub. No.: US 2012/0242765 A1
(43) Pub. Date: Sep. 27, 2012

(54) TRANSIENT VOLTAGE SUPPRESSION IN SOLID-STATE LIGHT FIXTURES

(76) Inventors: Salvatore Battaglia, Vancouver, WA (US); Alejandro V. Basauri, Beaverton, OR (US)

(21) Appl. No.: 13/069,170

(22) Filed: Mar. 22, 2011

(51) Int. Cl. B41J 2/01; F21S 4/00

(52) U.S. Cl. 347/102; 362/249.01; 362/249.02

(57) ABSTRACT

A lighting module has an array of solid state light emitters positioned to transmit ultraviolet light, a power supply electrically coupled to the array of solid state light emitters through a connector, and a transient voltage suppressor electrically coupled to the connector. A printing system includes a lighting module having an array of emitters, the lighting module electrically coupled to a power supply having a transient voltage suppressor, a print substrate delivery system positioned to receive light from the array of emitters, and an ink delivery system positioned to delivery ink to the print substrate such that the ink receives sufficient illumination from the lighting module to cure the ink. A lighting system has a lighting module having an array of light emitters, a power supply electrically coupled to the lighting module, and a transient voltage suppressor electrically coupled to the power supply.

### BACKGROUND

Light fixtures employing solid-state light emitting devices such as light-emitting diodes have several advantages over traditional arc-lamps. Solid-state fixtures generally run at lower operating temperatures, consume less power, generate less heat and typically cost less. These features have caused many industries that employ arc lamps to move to solid-state fixtures.

In other industries, advances in materials have also resulted in the use of solid-state light fixtures. For example, the printing industry has developed several different types of ink curable with ultraviolet radiation. Curing the ink can improve the image quality as it reduces or eliminates the spreading, smearing or transfer of the ink to unwanted surfaces.

These and other industries that cure inks and coatings have begun to employ solid-state fixtures, typically consisting of arrays of light-emitting elements, to perform curing. One such application involves large print systems. Large print systems may use roll-to-roll, or ‘web fed,’ processes in which the system prints ink on a very wide paper substrate as it rolls off of a large roll of paper. Another roll may then take up the paper after printing or the paper may route through a series of rollers to a cutting or folding machine. The system will typically use a large ultraviolet (UV) light source to cure the ink on the paper prior to take up or other routing.

In some instances, the large UV light source will consist of an array of light-emitting diodes (LEDs) or other solid-state light emitters. In some applications, the light source will use an external power supply that converts the alternative current (AC) power of the structure in which the system resides to direct current (DC) power for the light emitters. The DC power supplied generally includes a need for a power regulator to ensure that the light array receives a steady state power signal. Fluctuations in the signal may cause fluctuations in the luminance power output of the fixture.

As part of the power control circuitry, the system may include a power regulator. In electrically ‘noisy’ environments, such as typical large industrial setting in which these light fixtures operate, large power transients can damage the power control circuitry of the light fixture. This may render the light fixture inoperative, as well as damage other parts of the fixture, including the emitters.

### BRIEF DESCRIPTION OF THE DRAWINGS

FIG. 1 shows an embodiment of a print curing system.

FIG. 2 shows a power supply connection having transient voltage suppression.

FIG. 3 shows an embodiment of a circuit having transient voltage suppression.

### DESCRIPTION OF THE EMBODIMENTS

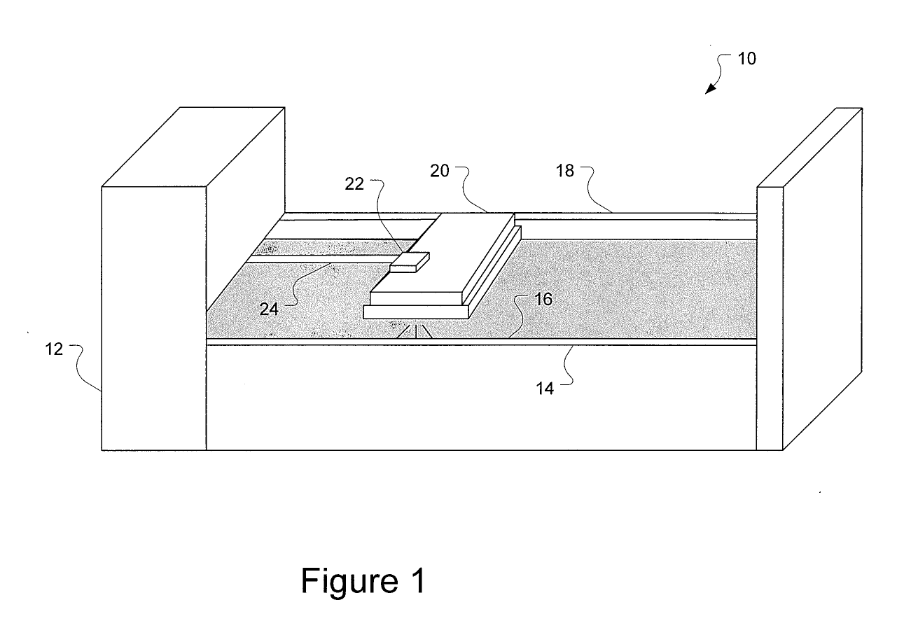

FIG. 1 shows a printing system. This printing system may be referred to as an industrial print system to differentiate it from a desktop printing system. Typically an industrial printing system will include a roll to roll, or web-fed, print substrate. While the embodiments discussed here consist of industrial printers, one should note that any type of solid-state light emitting system that suffers from high noise power signals that can damage the light emitters may benefit from these embodiments. These systems include anything from large, industrial printing systems to desktop or portable printing systems.

The printing system 10 of FIG. 1 has a housing 12, in this case a floor-mounted console. The printer has a bed 14 that supports the print substrate 16, which may be a web or sheet fed substrate. The print heads will typically reside in the left-hand side of the housing and the substrate that emerges on to the bed 14 has been printed and is ready for curing. The light module 20, which may be mounted on a rail such as 18, may move over the substrate both in the direction of the movement of the substrate and perpendicular to it, to allow for flexibility in substrate sizes. Alternatively, it may be fixed into place.

The light module 20 has a power supply connector 22 that may transfer power through cable 24 to the light module. The connector may be one of many types including a J5 power connector, but any type of power connector may be used. Generally, the light module will consist of an array of solid-state light emitters, such as light-emitting diodes, emitting light in the ultraviolet (UV) range. The power control circuitry of the solid-state light emitters has a limit on the amount of voltage it can receive before it suffers damage that may manifest itself as anywhere from reducing the illumination output of the emitters to causing them to fail completely.

The power supply voltage may have large swings causing the light emitters to receive voltages far higher than they can safely receive. By including a mechanism that allows the excess voltage to bleed off, the system can protect the light emitters from damage. For example, in large industrial printing environments, voltage swings may occur in the range of 300 V. In one example embodiment, the lighting modules operate at around 48-50 volts. To receive 300 volts would destroy the power supply circuitry that provides power to the emitters across the module.

By supplementing the power supply circuitry with transient voltage suppression, one can bleed off the excess voltage and reduce the amount of voltage experienced by the emitters. The following discussion revolves around a light module that operates at 48 volts, with the reservation that the embodiments shown here can apply to any level of voltage and any configuration of power supply.

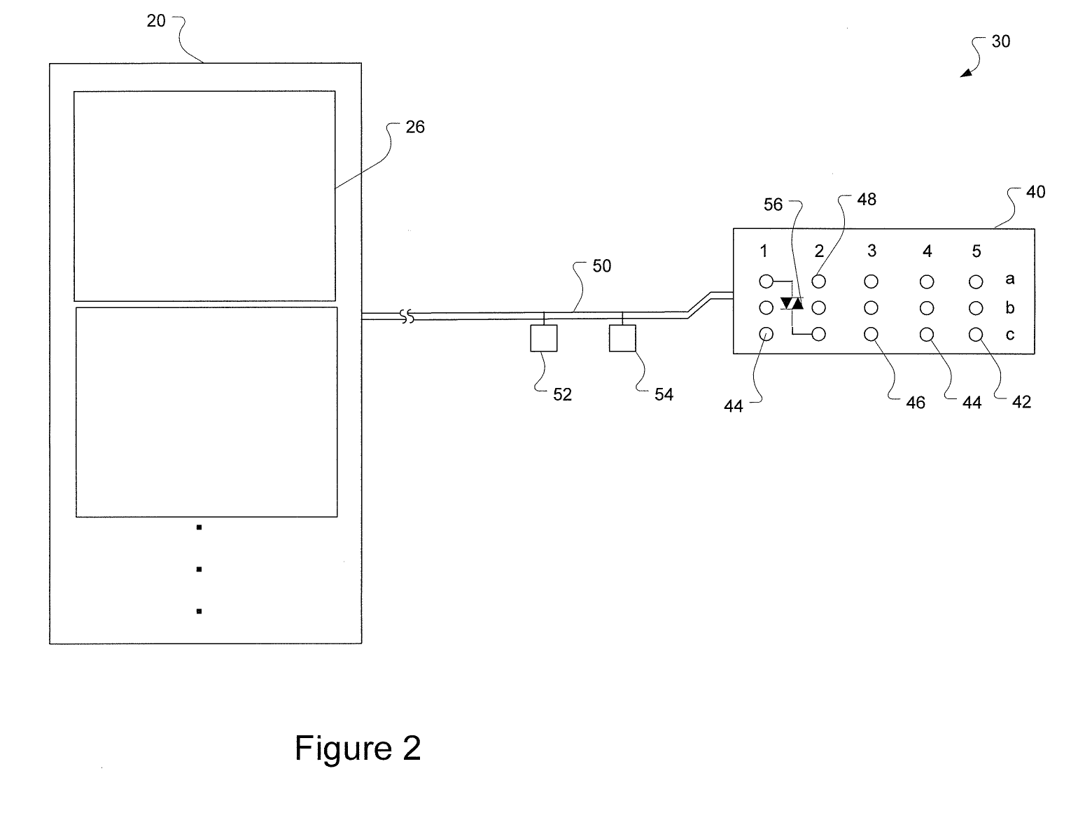

FIG. 2 shows a circuit diagram having a connector that includes transient voltage suppression. In this particular example, the light module 20 receives power through a connector 40. The light module 20 may consist of sub-arrays of light emitters such as 26, each mounted on different substrates, or multiple arrays mounted on one substrate.

In this particular embodiment, the power connector has 5 electrical connections, each having 3 pins labeled a, b and c. The connector in this example receives power at +48V on connection 1 (a, b, c) 44 and 5 (a, b, c) 42. The return, in this case 48V Return, is on connections 2 (a, b, c) 48 and 4 (a, b, c) 44, and ground is on connection 3(a, b, c) 46.

The transient voltage suppressor in this embodiment is connected between the +48V and the 48V_Return. In one particular embodiment, the suppressor is a bi-directional diode 56 connected between pins 1a and 2c. For the specific voltage levels here at 48 volts, the reversible diode may begin conducting at a level just above the nominal voltage in, but within the protective voltage variation of the light emitters.

For example, the power circuitry for the light emitters may expect to receive 48 volts in, but may be safe from damage to voltages as high as 60 volts. This expected voltage plus a range is what is referred to here as the nominal voltage, where the actual voltage may swing as high as 300 volts. In one embodiment, the reversible diode may begin conducting at around 54 volts. This ensures that the light emitters receive enough power to provide a needed level of illumination, while still protecting them from the high voltage swings.

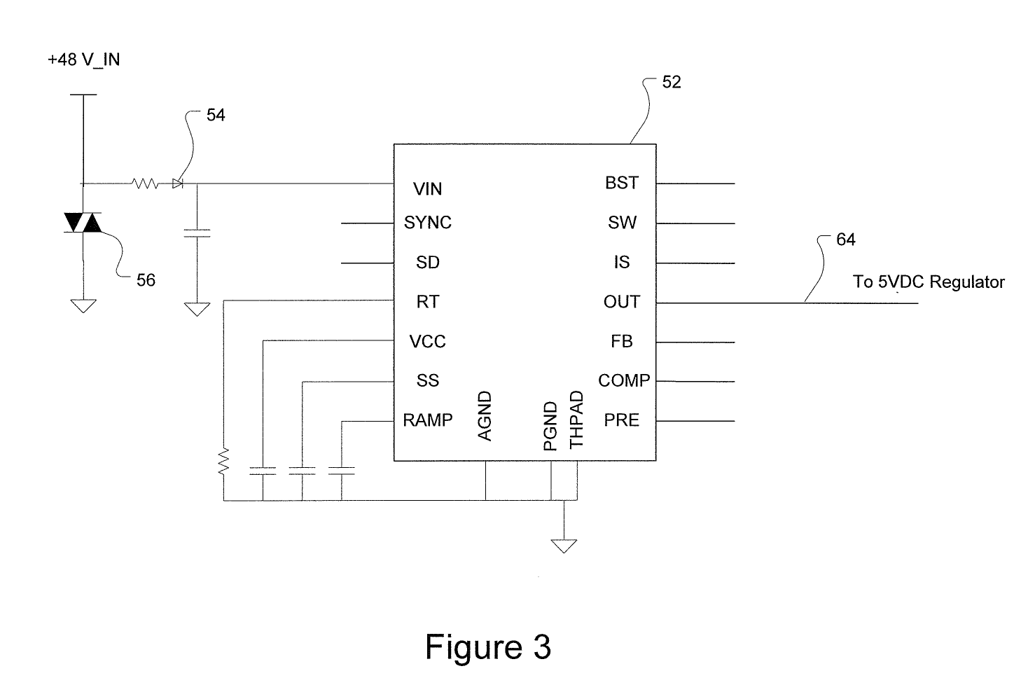

The power out of the connector may also be connected to a second diode or circuit element 54 and a switching regulator 52. These will be discussed in more detail with regard to FIG. 3.

The switching regulator controls the on/off state of the light emitters by controlling the power to the DC regulator that actually powers the emitters. FIG. 3 shows an embodiment of a switching regulator in more detail. The +48 V in signal has a transient voltage suppression mechanism, in this instance in the form of a bi-directional diode 56 connected to electrical ground. The diode 54 is a reverse polarity diode for extra protection. The switching regulator 52 is therefore protected from high voltage swings, while still operating to provide power to the 5 V DC regulator that in turn provides power to the control circuitry.

In the embodiments here, the transient voltage suppression involves a diode that begins conducting at a voltage level higher than the operating voltage of the power control circuitry, but at a level low enough to protect the circuitry from damage.

Other embodiments of transient voltage suppression could be used. For example, low pass filters with a combination of inductors, resistors or capacitors could also provide transient voltage suppression. However, this raises the component count, thereby increasing the circuit complexity, raising the possibility of opportunities for failures and even the cost.

Although there has been described to this point a particular embodiment for transient voltage suppression in solid-state lighting modules, it is not intended that such specific references be considered as limitations upon the scope of these embodiments.

What is claimed is:

1. A lighting system, comprising:
a lighting module having an array of light emitters;
a power supply electrically coupled to the lighting module; and
a transient voltage suppressor electrically coupled to the power supply.

2. The lighting system of claim 1, wherein the array of light emitters comprises an array of light emitting diodes arranged on at least one substrate.

3. The lighting system of claim 1, wherein the array of light emitters comprises multiple arrays of light emitting diodes arranged on multiple substrates.

4. The lighting system of claim 1, wherein the power supply includes a connector and the transient voltage suppressor resides in the connector.

5. The lighting system of claim 1, wherein the transient voltage suppressor further comprises at least one diode.

6. A printing system, comprising:
a lighting module having an array of emitters, the lighting module electrically coupled to a power supply having a transient voltage suppressor;
a print substrate delivery system positioned to receive light from the array of emitters; and
an ink delivery system positioned to delivery ink to the print substrate such that the ink receives sufficient illumination from the lighting module to cure the ink.

7. The printing system of claim 6, wherein the transient voltage suppressor comprises a diode.

8. The printing system of claim 6, wherein the ink comprises an ultraviolet-curable ink.

9. The printing system of claim 6, wherein the print substrate delivery system comprises a web-fed substrate.

10. A lighting module, comprising:
an array of solid state light emitters positioned to transmit ultraviolet light;
a power supply electrically coupled to the array of solid state light emitters through a connector; and
a transient voltage suppressor electrically coupled to the connector.

11. The lighting module of claim 10, wherein the array of solid state light emitters comprises an array of light emitting diodes.

12. The lighting module of claim 10, wherein the transient voltage suppressor is attached to a power in pin of the connector.

13. The lighting module of claim 11, wherein the connector is electrically coupled to a switching regulator.

14. The lighting module of claim 10, wherein the transient voltage suppressor comprises a diode.
